(19) United States
(12) Patent Application Publication
(10) Pub. No.: US 2025/0165813 A1
(43) Pub. Date: May 22, 2025

(54) COMPUTER PERFORMANCE VARIABILITY PREDICTION

(71) Applicant: Hewlett Packard Enterprise Development LP, Spring, TX (US)

(72) Inventors: Eitan Frachtenberg, Portland, OR (US); Sai Rahul Chalamalasetti, Newark, CA (US); Izzat El Hajj, Beirut (LB)

(21) Appl. No.: 18/518,276

(22) Filed: Nov. 22, 2023

(51) Int. Cl. G06N 5/022

(52) U.S. Cl. CPC G06N 5/022

(57) ABSTRACT

An ML model is trained to learn relationships between empirical distributions of telltale indicators and empirical distributions of variability benchmarks associated with executing an application on a first computer system having a first configuration. At least one empirical distribution of a first variability benchmark associated with the application is specified to the ML model. Output information indicative of at least one telltale indicator that is associated with the first variability benchmark is received from the ML model.

### BACKGROUND

Modern computer systems are highly nondeterministic, with the nondeterminism arising from various configuration differences among hardware, middleware, operating systems, and interference from multiple processes that can be simultaneously executed. Such nondeterminism can result in difficulty in predicting and explaining observed variability in performance and power consumption. Certain techniques attempt to predict single-point performance for given applications under known conditions; however, the variability in performance is inadequately described with single-point indicators of performance. Instead, performance variability is better represented by a distribution of the indicators of performance. The performance can be thought of as including a certain degree of randomness, similar to a random variable.

Approaching performance of computer systems in general as a random variable can lead to new approaches and models describing the relationship between hardware and software, for example. One goal of better understanding performance variability is the idea of “explainable performance” or the ability to break down and better understand, in actionable ways, the various factors affecting complex performance behaviors that are observed during operation, which manifest themselves in variability benchmarks associated with the execution of applications.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a depiction of a system for computer variability prediction in one embodiment;

FIG. 2 is a depiction of a machine-learning (ML) model in one embodiment;

FIG. 3 is a flowchart depicting a method of training the ML-model in one embodiment;

FIG. 4 is a flowchart depicting a method of using the ML-model in one embodiment;

FIG. 5 is a depiction of a compute node in one embodiment;

FIG. 6 is a depiction of a high-performance computing (HPC) cluster in one embodiment;

FIG. 7 is a flowchart depicting a method for predicting computer performance variability in one embodiment;

FIG. 8 is a flowchart depicting a method for predicting computer performance variability in one embodiment;

FIG. 9 is a flowchart depicting a method for predicting computer performance variability in one embodiment; and

FIG. 10 is a flowchart depicting a method of identifying computer performance variability in one embodiment.

### DETAILED DESCRIPTION

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically or collectively. Thus, as an example (not shown in the drawings), device “12-1” refers to an instance of a device class, which may be referred to collectively as devices “12” and any one of which may be referred to generically as a device “12”. In the figures and the description, like numerals are intended to represent like elements.

In the early days of digital computing, computer systems were relatively simple, and thus, performance modeling and evaluation of computer systems was also relatively simple, such as in the realm of 8-bit processor architectures running assembly code. With such early computer systems, estimating the run time of a loop, in one example of a variability benchmark, would involve simply multiplying a number of assembly instructions in the loop by the number of iterations, and dividing the product by the clock speed.

The performance of modern computer technology has become greatly advanced, more complex, and less deterministic. Many factors contribute to performance variability of computer systems, such as heterogeneous accelerators, multilevel networks, parallel and concurrent architectures, operating system (OS) heuristics, and layered software abstractions, as well as potential interference from various simultaneously executing processes in modular multi-tenant systems, such as cloud computing systems.

Some root causes for performance variability in modern computer systems have been postulated or identified. In some scenarios, when simultaneously executing processes share computer resources, such as local hardware resources or network resources, there can be contention and interference among those shared resources that results in performance variability. For example, certain background OS processes can cause contention and interference that can affect performance variability and are observed in variability benchmarks. In a further example, functionality on computer systems for energy management can result in performance variability. In some cases, memory management, such as so-called “garbage collection” routines that may reside in software or hardware can result in performance variability. In another example, certain global resources (e.g., network switches) can result in contention, such as contentions that may result from network traffic among other sources, leading to performance variability. Other sources of performance variability can include processor differences in multi-processor systems and cache limitations with certain processors, among others. When computer systems undergo maintenance activities, performance of certain resources may be constrained and cause performance variability. When data or task processing is subject to queuing, for example, delays resulting in performance variability can be observed. In some contexts, the available power may be constrained under certain conditions or at certain times, which can result in performance variability.

Because performance variability of computer systems may not be easily bounded in its extent or easily modeled with high accuracy, difficulties in explaining and predicting the performance variability may exist. However, the desirable impact of accurate performance variability estimates can be significant for a variety of reasons. The ability to accurately estimate performance variability can be beneficial in terms of the resource efficiency of computer systems, such as for optimal job and process scheduling, as well as power management. The ability to accurately estimate performance variability can affect the feasibility of certain procurement decisions for computer systems, for example, by accurately predicting that a given application may have better performance (as observed in variability benchmarks), a lower price-to-performance ratio, lower performance variability, lower tail latency, or combinations thereof, when the application was executed on one type of computer system versus another. In the development of computer systems and applications, having accurate performance variability estimates that are reflected in variability benchmarks can play a role in the design, validation, and regression testing of high-performance software and hardware components, including efforts at optimizing both software and hardware components.

Certain embodiments of this disclosure present an approach to modeling and predicting the variability in performance of computer systems, as observed in variability benchmarks. The modeling approach can identify and describe certain explanatory variables, referred to as “telltale indicators,” along with the variability of the telltale indicators themselves, that presumptively explain empirical distributions of the observed variability benchmarks. The telltale indicators may represent various types of computer system performance indicators, as will be described in further detail, and may include telltale indicators collected from the hardware using hardware performance counters, as well as telltale indicators collected from the OS using externally accessible metrics included with the OS.

In certain embodiments, methods and systems for computer performance variability prediction may use ubiquitous machine-learning (ML) models for predicting distributions of variability benchmarks rather than actual values of the variability benchmarks in any single instance. Certain embodiments may include so-called “black-box” predictions, such as derived from ML models comprised of neural networks that are subject to training. Certain embodiments may use statistical models and knowledge to derive insights and defined explanations of relationships between hardware and software. Certain embodiments may include a computational mechanism to automatically collect low-level performance metrics closely related to the hardware as telltale indicators, and empirical distributions of such telltale indicators, to model the distribution of user-level or high-level computer system performance. The low-level telltale indicators can be collected from the hardware and the OS and can be analyzed using ML models and statistical models. The ML models can be used to predict the shape and properties of a high-level variability benchmark distributions. The statistical models can be used to tie particular aspects of the high-level variability benchmark distribution to particular behaviors of the OS and the hardware to better understand the relationships among hardware and software in operation. Certain embodiments include statistically analyzing these relationships to provide insights on software performance, architectural features, and performance bottlenecks, and can be configured to provide automated suggestions, such as changes in configuration parameters, for potential optimizations for performance and reduced performance variability.

Certain embodiments may include inputs that are measurements of the values and variability of the telltale indicators, such as computer hardware counters. The measurements may be in aggregate form or a time series to assist in linking performance variability to different application phases or sections of actual code of the application. Certain embodiments may use automated ML techniques to estimate variability benchmarks as a response variable from the telltale indicators as explanatory variables. Certain embodiments may use automated statistical techniques to model the distribution of the variability benchmarks and extract potentially insightful relationships between the variability benchmarks and the telltale indicators. Certain embodiments may provide automated suggestions to users regarding how to optimize given applications to reduce performance variability and tail latency. Certain embodiments may interact with a system's resource manager (e.g., an OS scheduler) to optimize resource allocation for reduced performance variability and tail latency.

Certain embodiments may be used to measure performance variability (e.g., response variable or variability benchmarks) concomitantly with the variability of the telltale indicators identified, such as processor metrics, OS metrics (e.g., explanatory variables or telltale indicators). Certain embodiments may be used to analytically tie the explanatory variables and the response variable together to build a predictive model of application performance variability. Certain embodiments may be used to formulate relationships between different modes in the performance variability distribution and different explanatory variables to offer insights and quantitative explanations of the sensitivity of the application to different system factors. Certain embodiments may be used to predict performance and performance variability on unseen systems more accurately and to verify the accuracy with robust contextual confidence intervals. Certain embodiments may be used to link performance variability to application phases to assist with debugging of performance variability. Certain embodiments may be used to provide automated suggestions for optimizing performance variability and tail latency and/or to improve deadline adherence in real-time applications.

The methods and systems for computer performance variability prediction of this disclosure may provide various benefits associated with removing or reducing performance variability. For example, a quality of service (QoS) standard for computing services, such as a standard specified in a service level agreement (SLA) or other contract for computing services, can be optimized and made less susceptible to performance variability, which may be desirable for both vendors and buyers of such outsourced computing services. In multi-node application execution, such as bulk synchronous processing (BSP), overall performance may be increased by allowing nodes to synchronize their individual execution periods and reduce dead time waiting for nodes to finish by reducing performance variability, as manifested in variability benchmarks and their distribution, such that nodes complete execution within a shorter time window. For example, when variability benchmarks are more accurately identified, mismatched hardware configurations can be identified, while optimal hardware configuration can be proposed, such as for cloud and software-as-a-service solutions that can provide wide market access to supercomputing at different price points. In another example, scheduler data processing can be made more energy-aware more simply when a close relation between node sensors and application execution has been determined by analyzing variability benchmarks.

Certain embodiments will now be described with reference to the accompanying figures.

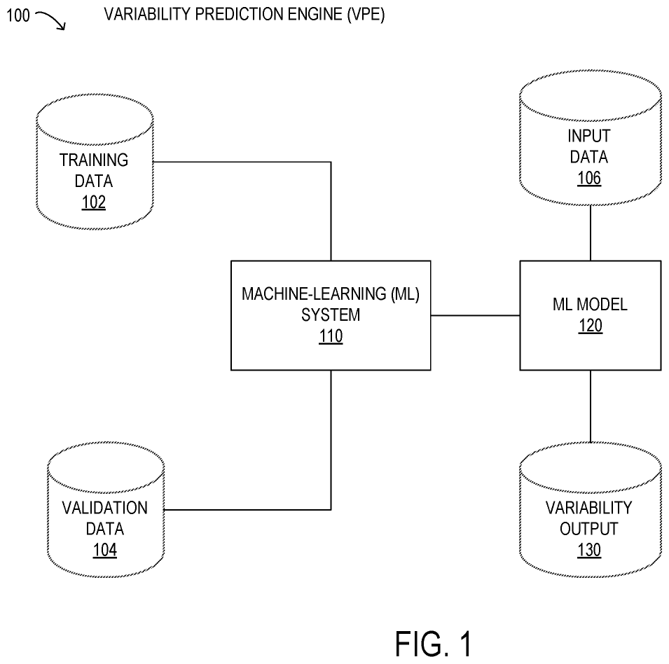

Referring now to FIG. 1 a variability prediction engine (VPE) 100 is depicted as a schematic block diagram. VPE 100 represents data and functional elements that can be computer-implemented, as described herein. As shown, VPE 100 includes a machine-learning (ML) system 110 that can train and export an ML model 120 that is usable for generating variability output 130, as will be described in further detail. Variability output 130 can include output data from VPE 100 that describes, predicts, identifies, and diagnoses performance variability distributions in computer systems executing applications. It is noted that the present disclosure is not primarily directed to predicting a variance of computer performance itself in a particular context, but rather, VPE 100 is capable of predicting the behavior of computer systems executing applications with respect to variability of performance in the form of distributions of the performance variability.

As noted above, modern hardware, operating systems (OS), and software applications (referred to herein as simply “applications”) are typically nondeterministic by design or by implementation such that their various empirical characteristics can be thought of as random variables. Consequently, a measured or empirical performance distribution of applications is accumulation or a composition of such random variables. The compositional relationship can be additive (normal), multiplicative (log-normal), compound (multimodal), or various combinations thereof. The compositional relationship may at times be too complex or too variable to predict a single variability benchmark, such as a run time for a given application in a given execution context. However, ranges or distributions of performance variability (e.g., of variability benchmarks) and dependent relationships of such distributions to underlying telltale indicators of hardware and software performance can be generally predicted. The observed empirical distribution of the variability benchmarks and the telltale indicators, combined with sensitivity testing can be used to tie behavioral modes of the telltale indicators to specific true distributions of the variability benchmarks. Such an approach as presented in embodiments disclosed herein can lead to identification and analysis of the role of a given computer configuration in the performance variability associated with executing the application.

As disclosed herein, the variability benchmarks associated with executing an application can be selected from at least one of: a run time, a response latency, a response latency probability, a data throughput rate, a makespan, an end timestamp, a start timestamp, or a data throughput capacity.

As disclosed herein, a true distribution can be characterized by at least one of:
statistical variables, including mean, median, mode position, mode quantity, mode magnitude;
spread variables, including standard deviation, standard error, variance, coefficient of variation;
a confidence interval; a high-density interval; or
at least one parameter for a curve fit, such as for a normal (Gaussian) curve fit, a bimodal curve fit, a multimodal curve fit, or a logmodal curve fit.

As disclosed herein, a configuration for a computer system (e.g., a compute node) can specify at least one of:
central processing unit (CPU) parameters, including a base clock frequency, a cache memory size, a number of cores, a number of logical processors, a peripheral bus clock speed;
graphics processing unit (GPU) parameters, including GPU version, GPU clock speed, GPU cache memory;
memory parameters, including physical memory size, number of memory cards, memory card size, memory interface, nominal memory write speed, nominal memory read speed, nominal memory latency, number of lanes, memory clock speed, memory access control, memory allocation control;
OS parameters, including version number, number of updates, update list, registry contents, directory contents;
network parameters, including network capacity, number of physical ports, type of physical ports, media type, power management mode; or
local storage parameters, including number of physical volumes, number of logical volumes, size of volumes, capacity/volume, file system identifier, file system version, storage media type, redundant volumes, file system write speed, file system read speed.

As disclosed herein, the telltale indicators can include at least one of:
central processing unit (CPU) metrics, including CPU % utilization, actual clock frequency, number of processes, number of threads, number of handles, cache events, CPU events, cycle counts, instruction counts, IO events, operating system events, a core identifier;
graphics processing unit (GPU) metrics, including GPU % utilization, GPU memory usage, GPU shared memory;
memory metrics, including memory usage, memory available, memory committed, memory cached, memory paged, memory non-paged;
OS metrics, including application runtime duration, code segment runtime duration, virtual memory size, application CPU time duration, application end timestamp, code segment end timestamp;
network metrics, including throughput rate, send data rate, receive data rate, network capacity rate, packet error rate, application network data usage, application network data rate; or
local storage metrics, including response time, average response time, % active time, transfer rate, file system latency, write speed, read speed, access time.

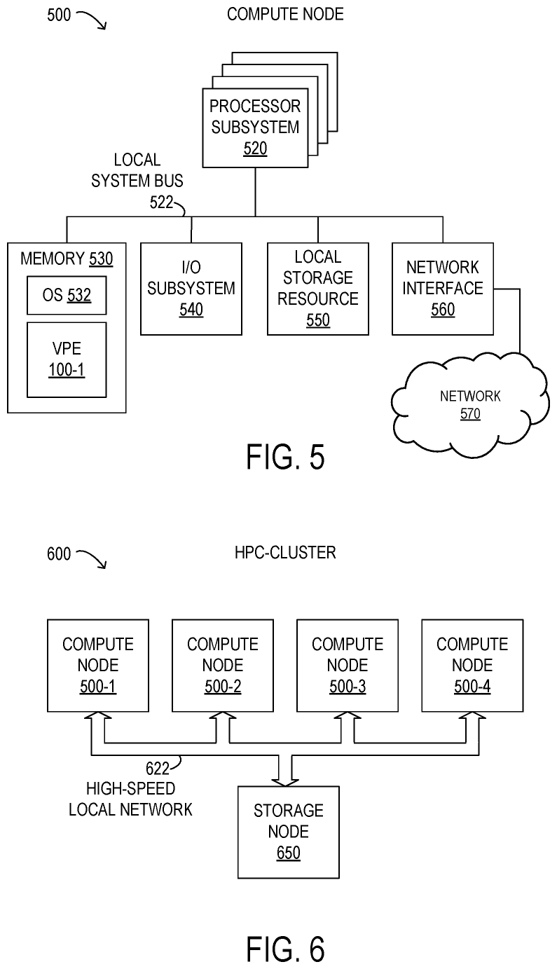

As shown in FIG. 1, in VPE 100, ML system 110 can receive training data 102 in order to train ML model 120 for a particular implementation, such as for a particular application executing on a given target computer platform (see also FIGS. 5 and 6). In some implementations, training data 102 may be collected directly from applications that are executing concurrently with ML system 110, such as on a large number of computer systems. For example, the same application may be executed on multiple computer systems to generate a baseline variability benchmark distribution that can represent or approach a “true distribution” for the variability benchmark. In various cases, ML system 110 can use training data 102 to train ML model 120 until a certain condition is met, such as a confidence interval for outputs of ML model 120 being within a certain range. In addition to training data 102, ML system 110 can access validation data 104 that can represent reference data that is known or expected to produce a desired result for comparison with training data 102. In this manner, the performance variability of ML model 120 being trained with training data 102 can be validated, such as to within a certain confidence level, using validation data 104.

In VPE 100, after ML model 120 has been sufficiently or acceptably trained using ML system 110, ML model 120 can be extracted for operation or use as a predictive engine for performance variability. In operation or use as a predictive engine for performance variability, ML model 120 can receive input data 106 that can be any new data for performance variability analysis, and can accordingly generate variability output 130 as resulting output. Variability output 130 can include information that identifies or isolates causal relationships between performance variability of an application that is measured using “variability benchmarks” associated with execution of the application in a given context, and “telltale indicators” that include computer system software and hardware metrics that can exhibit the causal relationships to the variability benchmarks. Variability output 130 can also include information that infers or suggests potential causes of observed variable behavior of the variability benchmarks based on the causal relationships, along with suggestions on how the observed variability, in the form of an “empirical distribution”, can be optimized or can attain or approach the desired true distribution. Accordingly, variability output 130 can further include information describing a prediction of the true distribution of variability benchmarks for an application in a given execution environment based on input data 106 that includes a relatively small number or size of empirical distributions of the variability benchmarks and the telltale indicators, such as based on a relatively small sampling of execution of the application, e.g., a small number of runs of the application. Variability output 130 can further include information describing a prediction of the true distribution of variability benchmarks for an application based on input data 106 that includes empirical distributions of the variability benchmarks and the telltale indicators from different execution environments, such as different configurations of computer systems that execute the application than were used for training data 102. Variability output 130 can also include information describing statistically derived relationships between the telltale indicators and the variability benchmarks that ML model 120 may further be capable of automatically generating.

In operation of VPE 100, the following five use cases are disclosed for descriptive purposes. It is noted that other use cases or combinations of use cases may also be realized with VPE 100.

Use Case 1: Pre-execution Prediction. An application is executed on a given computer system having a first configuration multiple times, such as a large number of instances of execution. Training data 102 including selected variability benchmarks are recorded over the number of executions along with some or all available telltale indicators. Using the variability benchmarks and the telltale indicators recorded as training data 102, ML model 120 is trained. The training may be a first training of ML model 120 in some embodiments. In other embodiments, the training may be augmented to prior training of ML model 120, such as by using different training data 102. The ML model 120 is then extracted after sufficient or desired training based on the first configuration. The ML model 120 is used with input data 106 that includes variability benchmarks and telltale indicators that are recorded during execution of the application using a second configuration that is different from the first configuration of the computer system used for training. The variability output 130 is generated by ML model 120 as output data that includes a prediction of a true distribution of at least one of the variability benchmarks for the application using the second configuration. Usage of ML model 120 can be repeated with different input data 106 for respectively different subsequent configurations of the computer system to generate respective variability output 130.

In further examples, a different application may be executed on the given computer system having the first configuration. The ML model 120 can be used to predict a true distribution of certain variability benchmarks for the different application. In certain cased, ML model 120 can provide such predictions without a large number of executions of the different application on the first configuration, such as by using telltale indicators and variability benchmarks for a single run of the different application as input data 106.

Use Case 2: Intra-execution Prediction. The ML model 120 is trained for the application executing on the first configuration of the computer system, as in Use Case 1. Then, execution of the application is initiated on the first configuration. During execution of the application, prior to completion of execution, input data 106 including variability benchmarks and telltale indicators are recorded and used by ML model 120 to generate, as variability output 130, certain characteristics of a true distribution of at least one of the variability benchmarks for continued execution of the application on the first configuration. For example, the characteristics may include predictions about the location of certain modes in the true distribution.

Use Case 3: Combined Pre/Intra-execution Prediction. The ML model 120 is trained for the application executing on the first configuration of the computer system, as in Use Case 1. Variability output 130 are generated as in Use Case 1. The variability output 130, including predicted true distributions of variability benchmarks, are used to schedule the application workload. Then, execution of the application is initiated on the first configuration and additional variability output 130 are generated using new input data 106 generated while the application executes. During execution of the application, prior to completion of execution, new input data 106 including variability benchmarks and telltale indicators are recorded and used by ML model 120 to generate new variability output 130. The new variability output 130 are used to modify the true distribution of at least one of the variability benchmarks generated in Use Case 1.

Use Case 4: Run Time Analysis. The ML model 120 is trained for the application executing on the first configuration of the computer system, as in Use Case 1 or Use Case 3. The variability benchmarks include run time of the application, for which the true distribution is obtained as a prediction from variability output 130. For an application having a true distribution including a long-tail run time, collect or obtain first input data 106 for a number of executions of the application. Using a statistical model on first input data 106, correlate telltale indicators contributing to the long-tail run time. Then, correlate telltale indicators having the strongest causal relationships with larger long-tail values for the run time. Then, propose modification of certain aspects of the first configuration, such as certain hardware or software settings or parameters, to reduce the long-tail run times. Use the best improved true distribution of the run time with the modified telltale indicators to predict an upper bound for long-tail run times of the application.

Use Case 5: Telltale Indicator Analysis. The ML model 120 is trained for the application executing on the first configuration of the computer system, as in Use Case 1 or Use Case 3. Use ML model 120 to predict true distributions of different variability benchmarks. Based on a true distribution of a given variability benchmark, use a statistical model on first input data 106 to identify telltale indicators contributing to the observed modality of the true distribution for the given variability benchmark. Generate multiple associations between modality for the given variability benchmark and different telltale indicators. Propose modifications of certain aspects of the first configuration, such as modification of hardware or software settings or parameters, to reduce variability of the given variability benchmark, or determine upper/lower bounds for the given variability benchmark. Repeat the procedure for different or relevant variability benchmarks to define bounds of performance variability for the application.

Besides the specific Use Cases 1-5 described above, VPE 100 may be used for various additional functionality. In one embodiment, VPE 100 can be used to predict, such as by using regression techniques, statistical values associated with various variability benchmarks, e.g., standard deviation, kurtosis, etc. In one embodiment, VPE 100 can be used to classify applications based on categories of variability/sensitivity, e.g., network-sensitive (variability benchmark distribution tied to network synchronization events), CPU-clock-sensitive (variability benchmark distribution tied to variations in clock speed due to power management), OS-sensitive (variability benchmark distribution tied to operating-system scheduling decisions), not-sensitive, among others. In one embodiment, VPE 100 can be used to predict the variability benchmark distribution, e.g., “exponential distribution with λ=0.5”, “log-normal distribution with μ=0.13, σ=1.1”, such as by using a Bayesian posterior from a prior measurement. In one embodiment, an application of interest is not isolated from other applications concurrently executing on a computer system. In this case, VPE 100 may measure and quantify variability benchmarks that are caused by interference from the other applications, by specifically correlating telltale indicators in the time domain with features such as original process, timestamp, and OS context-switch events. In one embodiment, when variability output 130 indicates a multimodal variability benchmark distribution, ML model 120 may automatically identify which telltale indicators contribute to which mode. Such predictions can be done with linear regression models, decision trees, support-vector decomposition, neural networks and deep learning, as well as various ensemble methods. In one embodiment, VPE 100 is applied to real-time applications to identify sources of variability in order to improve adherence to scheduling deadlines and to reduce tail latency. In one embodiment, VPE 100 can predict power variability (separate from performance variability) which can assist power managers in adhering to a certain power budget. In particular embodiments, VPE 100 can be used for optimization of bulk-synchronous processing (BSP) applications, such as executing on HPC cluster 600 (see FIG. 6). BSP applications can be tightly coupled applications in which a delay in one process or node can cause a delay for the entire application. For example, ML model 130 can point out the slow process and telltale indicators associated with delays, while proposing specific remedies (such as replacing/upgrading a hardware component).

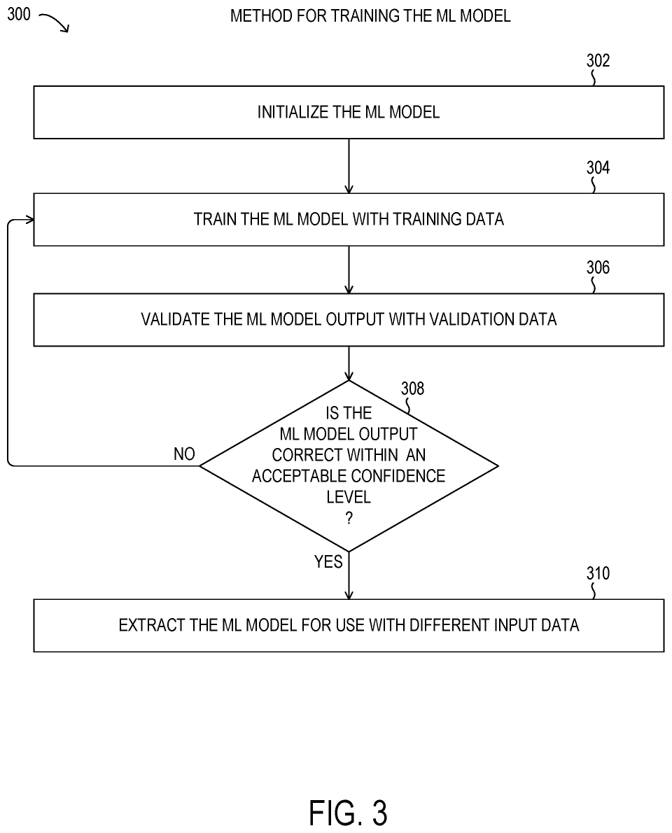

The operations and functions performed by ML system 110 can be summarized as data collection and data generation steps to extract ML model 120. Thus ML system 110 may first collect training data 102 from a system under test (not shown) and then extract corresponding ML model 120 to analyze the system under test, such as by using input data 106 to describe operational scenarios of the system under test different than embodied in training data 102. The collection and processing of training data 102 can be represented by step 302 in method 300 described below with respect to FIG. 3. In particular embodiments, the collection and processing of training data 102 can include identifying features of interest in the form of telltale indicators that are explanatory variables. The telltale indicators can include low-level hardware features, such as cache events or IO events, as well as OS operations, such as determining when a core identifier for a process/thread has changed (e.g., context-switches) or OS events (e.g., OS system calls). Then a training environment may be set up, such as a computer system having a given configuration being made available to execute an application of interest. The computer system used for training may be prepared to a defined initial state or condition, such as by restarting or flushing certain caches, queues, and memory buffers. The OS associated with the given configuration used for training can be configured for accessing telltale indicators to be recorded, such as by enabling certain OS system calls to access hardware metrics and counters indicative of performance features. Then the application of interest can be executed on the computer system, such as N number of times, where N can be a very large number, referred to as “sampling” or collecting training data. In some embodiments, a smaller value for N is used and the N number of runs are repeated as a block, with certain resetting actions that can be performed before each block is repeated. The sampling can be repeated until a stopping condition for the training is attained, such as by indicating that the collected number of samples is a representative sample size. In various embodiments, the stopping condition can rely on a Gelman-Rubin statistic or a Monte-Carlo standard error for evaluation. When the stopping condition is not met, further sampling can be performed to generate more training data 102. When the stopping condition for sampling is attained, ML system 110 may extract ML model 120 for stand-alone use.

When VPE 100 is used for distribution prediction, such as for predicting distributions of variability benchmarks, sampling may be performed to identify variability benchmarks of interest along with associated telltale indicators, and in particular, to identify features of the distribution of the variability benchmarks. The sampled data can be split into training data 102 and validation data 104 that ML system 110 can use for training ML model 120 for distribution prediction. The training can be performed until some confidence level indicates an acceptable degree of convergence or a desired accuracy level, for example. Then, ML model 120 can be used for distribution prediction of variability benchmarks.

When VPE 100 is used for statistical regression analysis such as to ascertain which telltale indicators are associated with (e.g., have a causal relationship to) which particular features of the distribution of certain variability benchmarks, variability output 130 and/or input data 106 can be used. A statistical analysis can be performed, such as on empirical distributions of variability benchmarks included in input data 106 or on predicted true distributions of variability benchmarks included in variability output 130, to identify those statistical features associated with modality of the respective distributions, such as a number of modes, a relative position of modes, a relative amplitude of modes, and outliers or other non-modal features. When the modes have been so identified and characterized, further statistical analysis can be applied to correlate particular telltale indicators with the modes identified. For example, when a distribution is identified to have a normal mode (Gaussian) indicative of a sum of random variables, various telltale indicators that can be presumptively associated with respective variability benchmarks can be analyzed to determine which sum of the telltale indicators can match the normal distribution. In another example, when a distribution is identified to have a lognormal mode indicative of a product of random variables, various telltale indicators that can be presumptively associated with respective variability benchmarks can be analyzed to determine which product combination of the telltale indicators can match the lognormal distribution. For observed combinations of the prior two examples, the sampled distributions may be split into modal subsets and the above analyses can be repeated on the modal subsets.

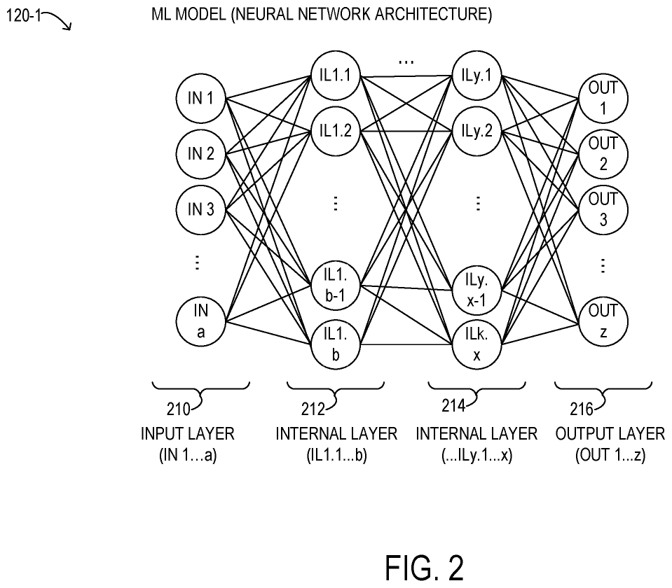

FIG. 2 depicts an ML model 120-1 in one embodiment. ML model 120-1 is depicted as a neural network architecture having an input layer 210, internal layers 212, 214, and an output layer 216. ML model 120-1 is a general representation that can be applied to receive input data 106 and generate variability output 130 as described above with respect to FIG. 1. Accordingly, input data 106 can be supplied to ML model 120-1 as input layer 210, while variability output 130 can be received from ML model 120-1 from output layer 216 in various embodiments. It is noted that although ML model 120-1 is depicted with a small set of nodes or artificial neurons (referred to herein as simply “neurons”), the dimensionality and structure of ML model 120-1 can be adapted for various specific types of data. For example, as shown, ML model 120-1 can be expanded to a number of input neurons, y number of input layers each having b . . . x number of neurons, and z number of output neurons. It is noted that a, b . . . x, y, and z can each have different dimensions, such as 103, 106, 109, 1012, among other values in various embodiments.

In the mathematical processing of ML model 120-1 of FIG. 2, the processing at each layer can be represented by an activation expression that can be generalized by Expression 1.

$${\sum }_{i} ( {w}_{i} {x}_{i} ) + b \qquad Expression 1$$

In Expression 1, i represents an index variable or dimension for each layer input, such as a, b . . . x, and z in FIG. 2; x represents the input value at each neuron, such as from another neuron; w represents a weighting coefficient applied at each neuron; and b represents a constant for each neuron. The output of each neuron can be represented by an activation function having the result of Expression 1 (e.g., the activation expression) as a parameter. In particular, ML model 120-1 may use deep learning (DL) that can be used to determine higher level highly complex data abstractions with a hierarchical, layered neural network architecture to enable learning. ML model 120-1 may learn by stating, describing, and implementing higher level, more abstract features on top of lower level, less abstract features. In this manner, ML model 120-1 can employ DL to analyze and learn from a large amount of unstructured data that can be unlabeled as well as uncategorized.

FIG. 3 is a flow chart of a method 300 for training ML model 120, such as described above with respect to VPE 100 in FIG. 1. Various method steps in method 300 may be omitted or rearranged in different embodiments.

Method 300 in FIG. 3 begins at step 302 by initializing the ML model. The initialization in step 302 may be associated with, or depend upon, the structure and content of training data 102, validation data 104, input data 106, and variability output 130 in VPE 100. At step 304, the ML model is trained with training data. At step 306 the ML model is validated with validation data. At step 308 a decision is made whether the ML model output is correct within an acceptable confidence level. When the result of step 308 is NO, method 300 loops back to step 304. When the result of step 308 is YES, method 300 proceeds to step 310 by extracting the ML model for use with different input data. The different input data can be input data 106.

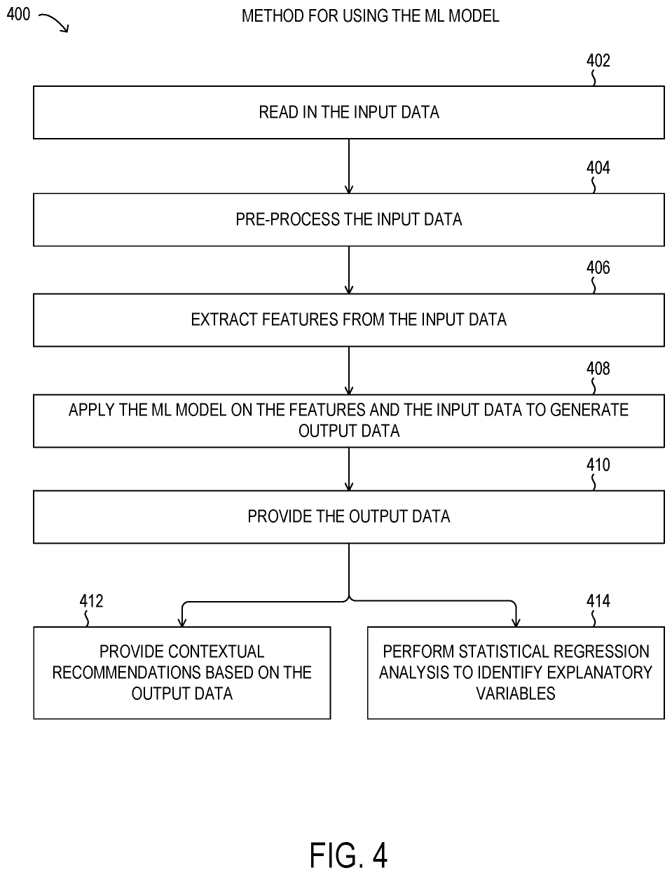

FIG. 4 is a flow chart of a method 400 for using ML model 120, such as described above with respect to VPE 100 in FIG. 1. Various method steps in method 400 may be omitted or rearranged in different embodiments.

Method 400 in FIG. 4 begins at step 402 by reading in the input data. The input data can be input data 106. At step 404, the input data are pre-processed. Pre-processing the input data in step 404 can involve filtering or smoothing or otherwise preparing input data 106 for use with ML model 130. At step 406, features can be extracted from the input data. Certain features or attributes of some of input data 106 extracted in step 406 may be used as other portions of input data 106. At step 408, the ML model is applied on the features and the input data to generate output data. The output data in step 408 can be variability output 130. At step 410, the output data is provided. At step 412, contextual recommendations are provided based on the output data. At step 414, statistical regression analysis is performed to identify explanatory variables. The explanatory variables in step 414 can be telltale indicators or configuration parameters, among others, and can be associated with certain variability benchmarks.

FIG. 5 illustrates a block diagram depiction of a compute node 500, in accordance with one or more embodiments of this disclosure. Embodiments described herein may be implemented using compute nodes, such as compute node 500, in an individual manner or in a cluster of multiple compute nodes, such as an HPC-cluster 600 that includes multiple compute nodes 500, as described below with respect to FIG. 6. Accordingly, compute node 500 may represent any of a variety of computer systems or computing devices, such as personal computers, desktop computers, laptops, servers, blade computers, modular computers, and HPC compute nodes, among others.

As shown in FIG. 5, compute node 500 includes a processor subsystem 520, a memory 530, a local storage resource 550, a network interface 560, an input/output (I/O) subsystem 540, and a local system bus 522 for interconnecting various local elements with processor subsystem 520. Network interface 560 may enable connection to a network 570, described in further detail below.

As shown in FIG. 5, processor subsystem 520 may include an integrated circuit, such as in the form of a chip, for interpreting and executing program instructions and process data. Processor subsystem 520 may include a general-purpose processor configured to execute program code accessible to processor subsystem 520. Processor subsystem 520 may include a special purpose processor in which certain instructions are incorporated into processor subsystem 520. Processor subsystem 520 may represent a single processor or multiple processors working together in compute node 500. Processor subsystem 520 may also represent multiple different kinds of processors, such as processors used for different types of tasks, including CPUs and GPUs used in compute node 500. Furthermore, processor subsystem 520 may include multiple cores or micro-cores (not shown) for executing program code or handling different processes. In some embodiments, processor subsystem 520 may interpret and execute program instructions and process data stored locally (e.g., in memory 530). In particular embodiments, processor subsystem 520 may interpret and execute program instructions and process data stored remotely (e.g., in a network storage resource accessible using network interface 560).

In FIG. 5, system bus 522 may represent a variety of suitable types of bus structures, e.g., a memory bus, a peripheral bus, or a local bus using various bus architectures in selected embodiments.

Also in FIG. 5, memory 530 may include a system, device, or apparatus operable to retain and retrieve program instructions and data for a period of time (e.g., computer-readable media). Memory 530 may include volatile memory such as random access memory (RAM), a cache memory, magnetic memory, among others. In some embodiments, memory 530 include any of various non-volatile memory that retains data after power is removed, such as a hard disk, an optical drive such as a compact disk (CD) drive or digital versatile disk (DVD) drive, a flash memory, electrically erasable programmable read-only memory (EEPROM), a memory card, a magnetic storage, an opto-magnetic storage, among others. Memory 530 may also include or represent a computer-readable medium (not shown) that includes, but is not limited to, portable or non-portable storage devices, optical storage devices, and various other mediums capable of storing, containing, or carrying instruction(s) and/or data. The computer-readable medium may include a non-transitory medium that stores data and does not include carrier waves and/or transitory electronic signals propagating wirelessly or over wired connections. The computer-readable medium may store code and/or processor-executable instructions that may represent a procedure, a function, a subprogram, a program, a routine, a subroutine, a module, a software package, a class, or any combination of instructions, data structures, or program statements, among other examples.

In FIG. 5, memory 530 is shown including an operating system (OS) 532, which may represent an execution environment for various program code executing on compute node 500. Operating system 532 may be any of a variety of standard or customized operating systems, such as but not limited to a Microsoft Windows® operating systems, a UNIX or a UNIX-based operating system, a mobile device operating system (e.g., Google Android™ platform, Apple® iOS, among others), an Apple® MacOS operating system, an embedded operating system, among others. Memory 530 is also shown including VPE 100-1 that represents at least some portions of VPE 100, described above with respect to FIG. 1, such that processor subsystem 520 of compute node 100 is capable of executing at least certain portions of VPE 100.

In compute node 500, I/O subsystem 540 may include a system, device, or apparatus generally operable to receive and transmit data to or from or internally within compute node 500. In different embodiments, I/O subsystem 540 may be used to support various peripheral devices, such as a touch panel, a display adapter, a keyboard, a touch pad, or a camera, among other examples. I/O subsystem 540 may represent, for example, a variety of communication interfaces, graphics interfaces, video interfaces, user input interfaces, and peripheral interfaces. For example, I/O subsystem 540 may support various output or display devices, such as a screen, a monitor, a general display device, a liquid crystal display (LCD), a plasma display, a touchscreen, a projector, a printer, an external storage device, or another output device. In some instances, I/O subsystem 540 can support multimodal systems that allow a user to provide multiple types of I/O to communicate with compute node 500.

In FIG. 5, local storage resource 550 may comprise non-volatile or persistent computer-readable media such as a hard disk drive, CD-ROM, and other type of rotating storage media, flash memory, EEPROM, or another type of solid state storage media, and may be generally operable to store instructions and data, and to permit access to stored instructions and data on demand. In some embodiments, local storage resource 550 may include a storage appliance or a storage subsystem (not shown) having one or more arrays of storage devices, such as for supporting redundancy, mirroring, and/or real-time data error correction and restoration.

Further, in FIG. 5, network interface 560 may facilitate connecting compute node 500 to network 570, which may represent a local area network (LAN), a wide area network (WAN) such as the Internet, mobile network, or another type of network. Network interface 560 can provide communication with another device, such as another computing node. Network interface 560 may include or support wireless networks or wired networks. The wired network media supported by network interface 560 may include analog media, universal serial bus (USB), Apple® Lightning®, Ethernet, fiber optics, a proprietary wired media, Public Switched Telephone Network (PSTN), Integrated Services Digital Network (ISDN), and an ad-hoc network media, among others. The wireless network media supported by network interface 560 may include Visible Light Communication (VLC), Worldwide Interoperability for Microwave Access (WiMAX), a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, IR communication wireless signal transfer, 3G/4G/5G/LTE cellular data network wireless signal transfer, radio wave signal transfer, microwave signal transfer, infrared signal transfer, visible light signal transfer, ultraviolet light signal transfer, wireless signal transfer along the electromagnetic spectrum, among others.

As shown in FIG. 5, network interface 560 may also include one or more Global Navigation Satellite System (GNSS) receivers or transceivers that are used to determine a location of computing node 500 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. In particular embodiments, network interface 560 can support expansion or addition of new network interfaces or media.

At least certain portions of compute node 500 may be implemented in circuitry. For example, the components of compute node 500 can include electronic circuits or other electronic hardware, which can include a programmable electronic circuit, a microprocessor, a graphics processing unit (GPU), a digital signal processor (DSP), a central processing unit (CPU), along with other suitable electronic circuits. Certain functionality incorporated into compute node 500 may be provided using executable code that is accessible to an electronic circuit, as described above, including computer software, firmware, program code, or various combinations thereof, to perform the methods and operations described herein. When specified, non-transitory media expressly exclude transitory media such as energy, carrier signals, light beams, and electromagnetic waves.

FIG. 6 illustrates a block diagram depiction of an HPC cluster, in accordance with one or more embodiments of this disclosure. Embodiments described herein may be implemented using an HPC cluster, such as HPC cluster 600 shown including multiple compute nodes 500 (see FIG. 5). Although four compute nodes 500-1, 500-2, 500-3, 500-4 are shown in FIG. 6 for descriptive purposes, it is noted that any number of compute nodes 500 may be used. In particular embodiments, a large number of compute nodes 500 may be aggregated in HPC cluster 600 to provide greater computing capacity, and may be used to implement a supercomputer in some embodiments. Accordingly, workloads, such as VPE 100-1 shown and described above with respect to FIG. 5, may be executed in a distributed manner in HPC cluster 600, e.g., by implementing multi-node application execution, such that compute nodes 500 share processing of the workload that may be performed in a parallel or simultaneous manner among compute nodes 500.

HPC cluster 600 can be described in general terms as a collection of computing nodes 500 that respectively include a local processor and local memory, and are interconnected by a dedicated high-bandwidth low-latency network, shown as high speed local network 622 in FIG. 6. HPC cluster 600 can accordingly aggregate and combine the computational power of multiple computing nodes 500 to perform large-scale workloads. HPC cluster 600 can provide flexibility and scalability of HPC resources so that computing power can be well matched to current and evolving workload needs, in an economical and seamless manner. HPC cluster 600 can also provide great flexibility of cluster configuration to handle task parallelization, data distribution, parallel execution, cluster monitoring and control, as well as combining the output of parallelized computations. Applications can execute on HPC cluster 600 in a local or distributed manner, such as on a single HPC compute node 500-1 or on multiple HPC compute nodes 500-2, 500-3, 500-4.

As shown in FIG. 6, HPC cluster 600 is shown including a storage node 650, which may represent a storage appliance that is compatible with high-speed local network 622. High-speed local network 622 may be a dedicated local bus such as InfiniBand, 40 Gb Ethernet, or peripheral connect interface express (PCIe), among others. Accordingly, storage node 650 can provide access to storage resources using low latency high-speed local network 622 to support HPC workloads processed using HPC cluster 600. It is further noted that HPC cluster 600 may include a dedicated network interface (not shown in FIG. 6) that can provide network connectivity, such as by using compute node 500.

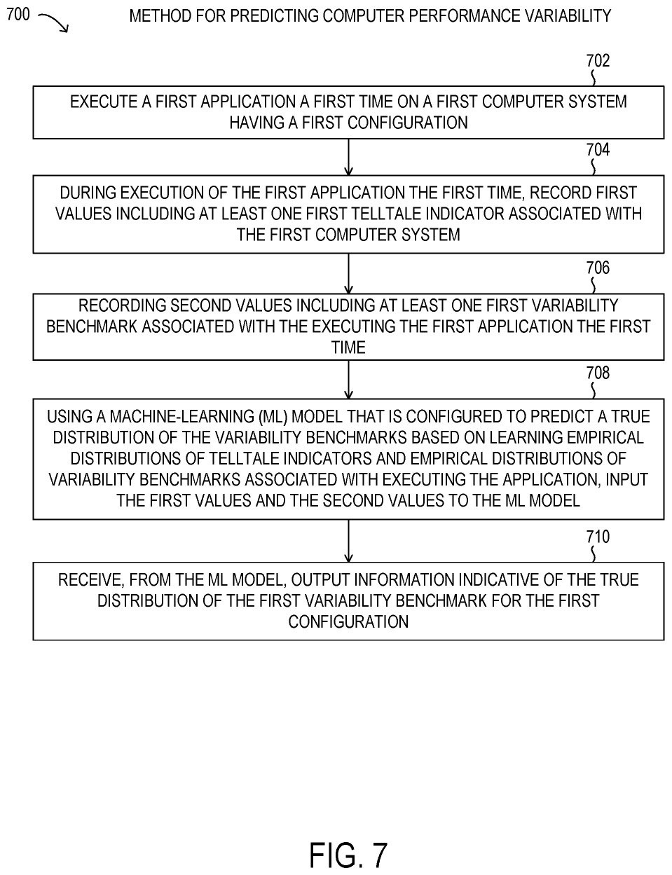

FIG. 7 is a flow chart of a method 700 for predicting computer performance variability. At least certain portions of method 700 can be performed using VPE 100 in FIG. 1, as described herein. Various method steps in method 700 may be omitted or rearranged in different embodiments.

In FIG. 7, method 700 may begin at step 702 by executing a first application a first time on a first computer system having a first configuration. At step 704, during the executing the first application the first time, first values including at least one first telltale indicator associated with the first computer system are recorded. At step 706, second values including at least one first variability benchmark associated with the executing the first application the first time are recorded. At step 708, using a machine-learning (ML) model that is configured to predict a true distribution of the variability benchmarks based on learning empirical distributions of telltale indicators and empirical distributions of variability benchmarks associated with executing the application, the first values and the second values are input to the ML model. At step 710, output information indicative of the true distribution of the first variability benchmark for the first configuration is received from the ML model.

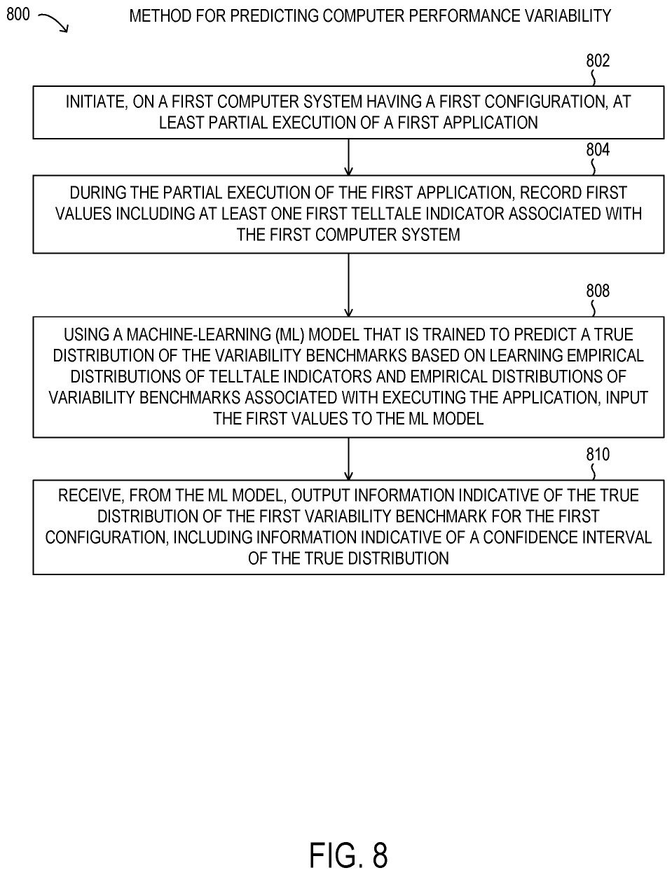

FIG. 8 is a flow chart of a method 800 for predicting computer performance variability. At least certain portions of method 800 can be performed using VPE 100 in FIG. 1, as described herein. Various method steps in method 800 may be omitted or rearranged in different embodiments.

In FIG. 8, method 800 may begin at step 802 by initiating at least partial execution of a first application on a first computer system having a first configuration. At step 804, during the partial execution of the first application, first values including at least one first telltale indicator associated with the first computer system are recorded. At step 808, using a machine-learning (ML) model that is trained to predict a true distribution of the variability benchmarks based on learning empirical distributions of telltale indicators and empirical distributions of variability benchmarks associated with executing the application, the first values are input to the ML model. At step 810, output information indicative of the true distribution of the first variability benchmark for the first configuration are received from the ML model, including information indicative of a confidence interval of the true distribution.

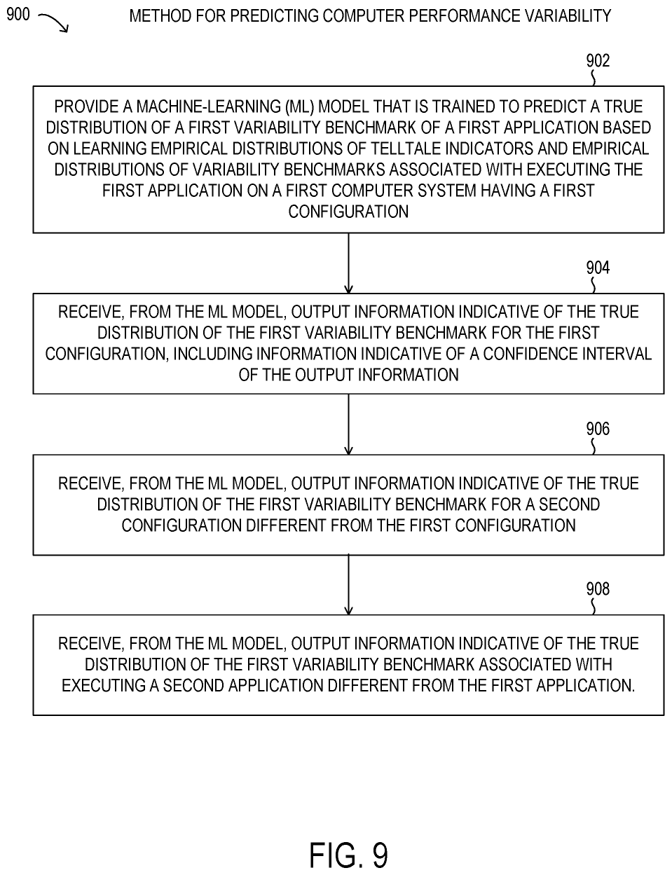

FIG. 9 is a flow chart of a method 900 for predicting computer performance variability. At least certain portions of method 900 can be performed using VPE 100 in FIG. 1, as described herein. Various method steps in method 900 may be omitted or rearranged in different embodiments.

In FIG. 9, method 900 may begin at step 902 by providing a machine-learning (ML) model that is trained to predict a true distribution of a first variability benchmark of a first application based on learning empirical distributions of telltale indicators and empirical distributions of variability benchmarks associated with executing the first application on a first computer system having a first configuration. At step 904, output information indicative of the true distribution of the first variability benchmark for the first configuration are received from the ML model, including information indicative of a confidence interval of the output information. At step 906, output information indicative of the true distribution of the first variability benchmark for a second configuration different from the first configuration are received from the ML model. At step 908, output information indicative of the true distribution of the first variability benchmark associated with executing a second application different from the first application are received from the ML model.

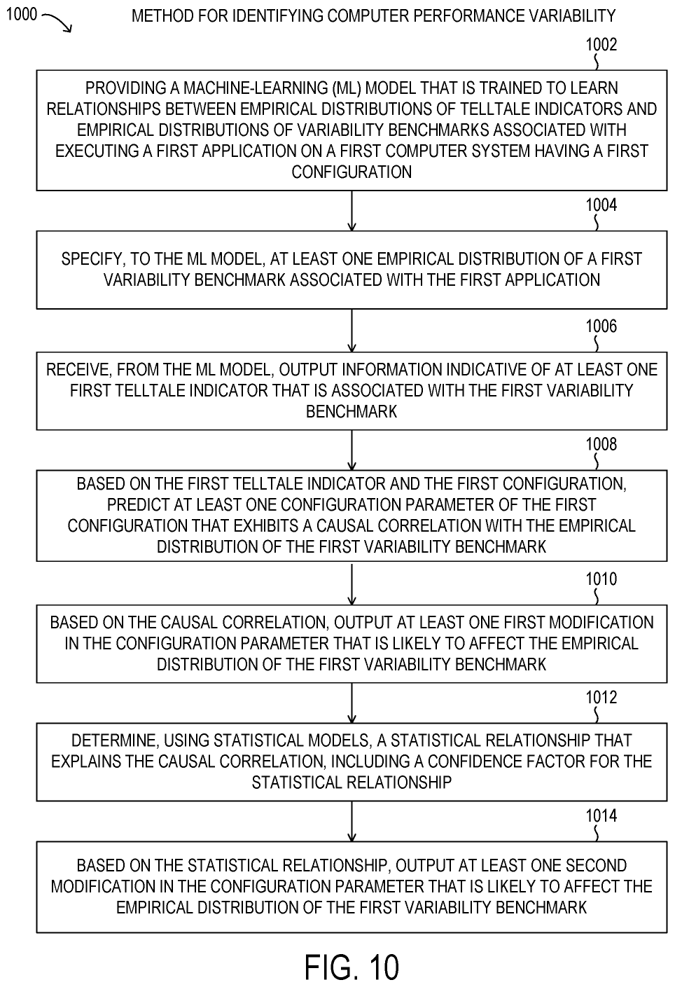

FIG. 10 is a flow chart of a method 1000 for predicting computer performance variability. At least certain portions of method 900 can be performed using VPE 100 in FIG. 1, as described herein. Various method steps in method 1000 may be omitted or rearranged in different embodiments.

In FIG. 10, method 1000 may begin at step 1002 by providing a machine-learning (ML) model that is trained to learn relationships between empirical distributions of telltale indicators and empirical distributions of variability benchmarks associated with executing a first application on a first computer system having a first configuration. At step 1004, at least one empirical distribution of a first variability benchmark associated with the first application is specified to the ML model. At step 1006, output information indicative of at least one first telltale indicator that is associated with the first variability benchmark is received from the ML model. At step 1008, based on the first telltale indicator and the first configuration, at least one configuration parameter of the first configuration that exhibits a causal correlation with the empirical distribution of the first variability benchmark is predicted. At step 1010, based on the causal correlation, at least one first modification in the configuration parameter that is likely to affect the empirical distribution of the first variability benchmark is output. At step 1012, using statistical models, a statistical relationship that explains the causal correlation is determined including a confidence factor for the statistical relationship. At step 1014, based on the statistical relationship, at least one second modification in the configuration parameter that is likely to affect the empirical distribution of the first variability benchmark is output.

Certain implementation examples of the method and systems disclosed herein for computer variability prediction are described below.

### Example 1

An application that is very sensitive to dynamic random access memory (DRAM) latency is identified. Using two different computer systems having respective two different configurations, variability output 130 of VPE 100 indicates that certain variability benchmarks, such as run time of the application, show that a higher performance is exhibited on a first computer system having a telltale indicator with values associated with lower DRAM latency than on a second computer system having values associated with higher DRAM latency. However, other differences in configuration parameters, such as differences in CPU clock speed between the first computer system and the second computer system, may obscure or mask the correlation to DRAM latency that is made apparent by variability output 130.

In other instances, on the first computer system, in which other telltale indicators remain the same, variability output 130 of VPE 100 indicates that CPU migrations that migrate a process for the application from one non-uniform memory access (NUMA) node to another. Other telltale indicators associated with higher performance can be indicated by variability output 130 of VPE 100, such as a telltale indicator for a number of L3 cache misses.

### Example 2

It is observed that the computational resources of a large HPC cluster (see also HPC cluster 600 in FIG. 6) configured as a supercomputer are typically managed by a batch job scheduler, such as Simply Linux Utility for Resource Management (SLURM). When a new job, such as an application, is queued for execution, the scheduler decides when and on which HPC nodes to execute the job. The scheduler uses a run-time estimate for the job to schedule multiple short jobs that are expected to complete execution before the resources consumed by the short jobs will be used for another subsequent job that can be larger or higher-priority. The run-time estimates for the short jobs are either calculated or obtained externally. However, during execution of the short jobs, the actual run-times of the short jobs do not correspond to the estimates, partly due to performance variability of certain HPC nodes. As a result, undesired action is taken by the job scheduler, such that jobs that exceed their allotted run time may be killed (leading to waste) or jobs with higher priority are delayed.

Instead, variability output 130 of VPE 100 is used to provide a more accurate run-time estimate, for example by predicting a true distribution of run-time as a variability benchmark. The prediction by VPE 100 provides an upper bound for an expected range of run-times with an estimated degree of confidence, which is incorporated into scheduling decisions to avoid killing or delaying of jobs. Further details of an implementation of Example 2 are described below.

At time 14:00, high-priority Job A is queued and requests 3,000 processors for execution on an HPC cluster from the job scheduler for the HPC cluster. Based on the variability output 130 for Job A at time 14:00, the job scheduler ascertains that 2,000 processors are available, while a Job B is currently executing using 1,000 processors of the HPC cluster. The job scheduler decides to schedule Job A at time 14:30, when Job B is expected to complete.

At time 14:10, a low-priority Job C is queued and requests 1,000 processors for execution on the HPC cluster from the job scheduler. The job scheduler initially estimates, absent variability output 130, that Job C will have a run-time of 15 minutes. The job scheduler determines that Job C can be backfilled ahead of Job A in the execution queue because Job C is not expected to affect the execution time of Job A. However, in actuality, the true distribution of the variability benchmark that is the run-time of Job C, as correctly predicted by variability output 130, indicates that Job C has a 20% probability of exceeding 15 minutes and less than 1% probability of exceeding 20 minutes. Based on the true distribution provided by variability output 130, the job scheduler makes a decision on whether or not to execute Job C at time 14:10 based on predetermined policies. Since low-priority Job C pending in the queue has a probability greater than 99% of completing execution before 14:30, the job scheduler backfills Job C ahead of Job A, which remains scheduled at 14:30. In this manner, the job scheduler is able to improve utilization of the HPC cluster and avoid unused downtime of the HPC cluster, which is economically desirable and made possible by VPE 100.

### Example 3

During the procurement of CPUs for a given configuration of a new computer system, different CPU options are often available for purchase for the same CPU model, which can involve choosing from a number of cores, a cache size, a clock frequency, among other CPU features. The basis for making such CPU-related feature choices during procurement can be difficult or unclear, since the business impact of such choices in a given enterprise may be undefined or unknown. As a result, a more or less powerful CPU configuration may be finally chosen based on other criteria, such as a procurement budget available, rather than an actual performance impact to the enterprise, which is undesirable and can adversely affect the enterprise, either financially or in terms of user productivity, when a mismatched CPU is chosen.

By using variability output 130 of VPE 100, the true distributions of variability benchmarks associated with existing computer systems can be predicted and can be used for a predictive analysis of a new configuration for the new computer systems to be procured. Such a predictive analysis enabled by variability output 130 can better color decisions about the value or utility of certain CPU features included in the new configuration, by showing an impact of various CPU features on the true distributions of variability benchmarks for the applications and conditions actually experienced by users in the enterprise. In this manner, CPU options can be chosen that provide overall higher performance and lower variability for the enterprise, which is desirable.

For example, variability output 130 can indicate that an existing configuration for an enterprise server often exhibits high-level cache misses when the CPU is operating under typical application workloads for the enterprise. This information can guide the procurement decision for a next enterprise server generation to include a larger cache size when the new CPU is chosen.

Similarly, when variability output 130 indicates that a page miss rate is higher on a second enterprise server than on other servers, VPE 100 can also predict that having larger sized DRAM modules would improve performance and reduce variability. Specifically, VPE 100 can be used to predict the relationship between the page miss rate and the size of DRAM modules on various servers, and thus, enable a comparison of such relationships among the servers.

### Example 4

It is observed that certain applications can exhibit very long-tailed performance that results in certain execution instances of the application having excessively long run times. In certain large enterprise contexts where billions of transactions are processed daily, the cost impact of such extended run times for application workloads can be quite large and economically important, since the cost of such operating such large data centers is very high.

By using VPE 100, variability output 130 as well as the statistical modeling using variability output 130 can associate variability benchmarks having a long-tail distribution for run time with composite telltale indicators that point to particular aspects of the configuration of the computer system used. The empirical distribution of the telltale indicators predicted by variability output 130 may indicate anomalous situations (e.g., high CPU temperature) or normal, yet infrequent operational situations like an OS service waking up to do routine maintenance, that explain the observed behavior. Furthermore, as noted, variability output 130 can include confidence and magnitude levels for the relationships discovered or predicted between the variability benchmarks and the telltale indicators. With such valuable insights provided by VPE 100, remedial action to reduce the observed variability can be focused on high-impact or high-likelihood telltale indicators having a causal relationship to the observed variability benchmarks.

Specifically, the latencies of queries to a large-language model (LLM) generative artificial intelligence (AI) application have been observed to include very large latencies resulting in very long run times, which is undesirable. Using VPE 100, the true distribution predicted for the run time of the queries (variability benchmark) by variability output 130 indicates a log-normal distribution with 98% confidence, suggesting that the true distribution is a result of a product (e.g., representing compounding of two or more telltale indicators that behave as random variables).

A Bayesian linear regression is used for a statistical model to fit the logarithm of the query run time (variability benchmark) against various telltale indicators and combinations or permutations thereof. Most telltale indicators are found to have negligible influence on the query run time, but six telltale indicators are found to have a p-value of less than 0.05, indicating statistical significance of the six telltale indicators. Further stepwise regression is performed to identify the single most influential telltale indicator, the interaction between the telltale indicators “query length” and “available RAM”, with p<0.001, indicating a high degree of statistical significance. This result is used to proscribe a change in the load balancer that sends long queries for execution by compute nodes with additional available RAM, and sends shorter queries for execution by compute nodes with lesser available RAM.

### Example 5

An image resizing service performs image reduction workloads from an input image sized 640×640 pixels to an output image sized 320×320 pixels. The true distribution of the variability benchmark of run time is predicted by VPE 100 and shows that the true distribution appears bimodal: 70% of executions of the service have a run time very close to is, and 30% of executions of the service have a run time very close to 3 s. Using VPE 100 to identify relationships between the run time (variability benchmark) and various telltale indicators, variability output 130 indicates that telltale indicators associated with the input data do not show little or no association with the run time. In other words, VPE 100 predicts that the properties of the input image do not influence the run time to any meaningful degree. However, variability output 130 does predict a strong association with telltale indicators of a number of core migrations and processor identifier, with statistically significant confidence levels. Variability output 130 further predicts that the strong association is valid for CPUs from a first manufacturer but is not valid for CPUs from a second manufacturer. For configurations including CPUs from the first manufacturer, variability output 130 provides indications that cores that are situated farther from system memory result in a different execution mode for the telltale indicator (run time) as evident in the true distribution, such that run time is dominated by latency of such memory operations that last three times longer than accessing memories closer to the core. Accordingly, VPE 100 provides a prescriptive recommendation to bind each process of service to a single core closest to the memory storing the input data, resulting in elimination of the three times longer mode of execution, which is desirable.

In summary, the methods and systems disclosed herein for predicting computer variability can be used to explain performance variability of applications executing on existing computer systems or nodes, in order to characterize, debug, and improve performance. Certain embodiments can predict performance variability of applications to be executed on planned or in-design new computer systems or nodes. Certain embodiments can measure, control, and reduce variability in HPC clusters and AI applications that can be very sensitive to synchronization mismatches. Certain embodiments can optimize training/inference performance of HPC clusters and AI applications by identifying some causes for outlier performance and subsequently eliminating or mitigating such causes. Certain embodiments can improve resource efficiency and resource management on supercomputers and HPC clusters. Certain embodiments can predict or recommend specific CPU and associated peripheral equipment combinations that minimize variability, such as observed in empirical distributions of variability benchmarks. Certain embodiments can identify potential cross-application interferences that manifest in variability benchmarks of application execution. Certain embodiments can provide feedback, discovery, and insights of true distributions of variability benchmarks for improving scheduling decisions made by a job scheduler. Certain embodiments can identify hardware resources to throttle up/down based on impact on empirical distributions of variability benchmarks.

As disclosed herein, an ML model can be trained with observed variability benchmarks and telltale indicators for an application executing on a computer system having a given configuration to predict a true distribution of variability benchmarks. The variability benchmarks can be correlated with the telltale indicators to determine modes in the true distribution associated with particular telltale indicators. A causal relationship between certain telltale indicators and variability benchmarks can be determined. Prescriptive measures to improve observed performance in variability benchmarks, such as modification of telltale indicators, can be provided.

As disclosed herein, an ML model can be trained to learn relationships between empirical distributions of telltale indicators and empirical distributions of variability benchmarks associated with executing an application on a first computer system having a first configuration. At least one empirical distribution of a first variability benchmark associated with the application is specified to the ML model. Output information indicative of at least one telltale indicator that is associated with the first variability benchmark is received from the ML model.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process or method can be terminated when its operations are completed, but may have additional steps not included in a flow chart. A process may correspond to a method, a function, a procedure, a subroutine, a subprogram, among others. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, among others. Examples of computer-readable media that may be used to store instructions, information used, and/or information created during methods according to described examples include magnetic or optical disks, flash memory, USB devices provided with non-volatile memory, networked storage devices, among others.

In the above description of the figures, any component described with regard to a figure, in various embodiments described herein, may be equivalent to one or more same or similarly named and/or numbered components described with regard to any other figure. For brevity, descriptions of these components may not be repeated with regard to each figure.

Throughout the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, the use of ordinal numbers is to distinguish between the elements, such as for classification purposes. By way of an example, a first element is distinct from a second element, and the first element may encompass more than one element and succeed (or precede) the second element in an ordering of elements.

While this disclosure has been described with reference to illustrative embodiments, this description is not intended to be construed in a limiting sense. Various modifications and combinations of the illustrative embodiments, as well as other embodiments, will be apparent upon reference to the description.

What is claimed is:

1. A method for predicting computer performance variability, the method comprising:
initiating, on a first computer system having a first configuration, at least partial execution of a first application;
during the partial execution of the first application, recording first values including at least one first telltale indicator associated with the first computer system; using a machine-learning (ML) model that is trained to predict a true distribution of the at least one first variability benchmark based on learning empirical distributions of telltale indicators and empirical distributions of variability benchmarks associated with executing the first application, inputting the first values to the ML model; and
receiving, from the ML model, output information indicative of the true distribution of the first variability benchmark for the first configuration, including information indicative of a confidence interval of the true distribution.

2. The method of claim 1, wherein the first variability benchmark is selected from at least one of: a run time, a response latency, a response latency probability, a data throughput rate, a makespan, an end timestamp, a start timestamp, or a data throughput capacity.

3. The method of claim 1, wherein the true distribution is characterized by at least one of:
statistical variables, including mean, median, mode position, mode quantity, mode magnitude;
spread variables, including standard deviation, standard error, variance;
a confidence interval;
a high-density interval; or
at least one parameter for a curve fit, including for a normal (Gaussian) curve fit, a bimodal curve fit, a multimodal curve fit, or a logmodal curve fit.

4. The method of claim 1, wherein the first configuration for the first computer system specifies at least one of:
central processing unit (CPU) parameters, including a base clock frequency, a cache memory size, a number of cores, a number of logical processors, peripheral bus clock speed;
graphics processing unit (GPU) parameters, including GPU version, GPU clock speed, GPU cache memory;
memory parameters, including physical memory size, number of memory cards, memory card size, memory interface, nominal memory write speed, nominal memory read speed, nominal memory latency, number of lanes, memory clock speed, memory access control, memory allocation control;
operating system (OS) parameters, including version number, number of updates, update list, registry contents, directory contents, power management mode;
network parameters, including network capacity, number of physical ports, type of physical ports, media type; or
local storage parameters, including number of physical volumes, number of logical volumes, size of volumes, capacity/volume, file system identifier, file system version, storage media type, redundant volumes, file system write speed, file system read speed.

5. The method of claim 1, wherein the telltale indicators include at least one of:
central processing unit (CPU) metrics, including CPU % utilization, actual clock frequency, number of processes, number of threads, number of handles, cache events, CPU events, cycle counts, instruction counts, IO events, operating system events, a core identifier;
graphics processing unit (GPU) metrics, including GPU % utilization, GPU memory usage, GPU shared memory;
memory metrics, including memory usage, memory available, memory committed, memory cached, memory paged, memory non-paged;
operating system (OS) metrics, including application runtime duration, code segment runtime duration, virtual memory size, application CPU time duration, application end timestamp, code segment end timestamp;
network metrics, including throughput rate, send data rate, receive data rate, network capacity rate, packet error rate, application network data usage, application network data rate; or
local storage metrics, including response time, average response time, % active time, transfer rate, file system latency, write speed, read speed, access time.

6. A method comprising:
providing a machine-learning (ML) model that is trained to learn relationships between empirical distributions of telltale indicators and empirical distributions of variability benchmarks associated with executing an application on a first computer system having a first configuration;
specifying, to the ML model, at least one empirical distribution of a first variability benchmark associated with the application; and
receiving, from the ML model, output information indicative of at least one telltale indicator that is associated with the first variability benchmark.

7. The method of claim 6, further comprising:
receiving, from the ML model, output information indicative of a true distribution of the first variability benchmark for a second configuration different from the first configuration.

8. The method of claim 6, wherein the first variability benchmark is selected from at least one of: a run time, a response latency, a response latency probability, a data throughput rate, a makespan, an end timestamp, a start timestamp, or a data throughput capacity; and
wherein a true distribution is characterized by at least one of:
statistical variables, including mean, median, mode position, mode quantity, mode magnitude;
spread variables, including standard deviation, standard error, variance;
a confidence interval;
a high-density interval; or
at least one parameter for a curve fit, including for a normal (Gaussian) curve fit, a bimodal curve fit, a multimodal curve fit, or a logmodal curve fit.

9. The method of claim 6, wherein the first configuration for the first computer system specifies at least one of:
central processing unit (CPU) parameters, including a base clock frequency, a cache memory size, a number of cores, a number of logical processors, peripheral bus clock speed;
graphics processing unit (GPU) parameters, including GPU version, GPU clock speed, GPU cache memory;
memory parameters, including physical memory size, number of memory cards, memory card size, memory interface, nominal memory write speed, nominal memory read speed, nominal memory latency, number of lanes, memory clock speed, memory access control, memory allocation control;
operating system (OS) parameters, including version number, number of updates, update list, registry contents, directory contents, power management mode;
network parameters, including network capacity, number of physical ports, type of physical ports, media type; or
local storage parameters, including number of physical volumes, number of logical volumes, size of volumes, capacity/volume, file system identifier, file system version, storage media type, redundant volumes, file system write speed, file system read speed.

10. The method of claim 6, wherein the at least one telltale indicator includes at least one of:
central processing unit (CPU) metrics, including CPU % utilization, actual clock frequency, number of processes, number of threads, number of handles, cache events, CPU events, cycle counts, instruction counts, IO events, operating system events, a core identifier;
graphics processing unit (GPU) metrics, including GPU % utilization, GPU memory usage, GPU shared memory;
memory metrics, including memory usage, memory available, memory committed, memory cached, memory paged, memory non-paged;
operating system (OS) metrics, including application runtime duration, code segment runtime duration, virtual memory size, application CPU time duration, application end timestamp, code segment end timestamp;
network metrics, including throughput rate, send data rate, receive data rate, network capacity rate, packet error rate, application network data usage, application network data rate; or
local storage metrics, including response time, average response time, % active time, transfer rate, file system latency, write speed, read speed, access time.

11. The method of claim 6, wherein multiple telltale indicators are associated with the empirical distribution of the first variability benchmark, and wherein each of the telltale indicators appears as a mode in the empirical distribution of the first variability benchmark.

12. The method of claim 6, further comprising:
based on the telltale indicator and the first configuration, predicting at least one configuration parameter of the first configuration that exhibits a causal correlation with the empirical distribution of the first variability benchmark; and
based on the causal correlation, outputting, at least one first modification in the configuration parameter that is likely to affect the empirical distribution of the first variability benchmark.

13. The method of claim 12, further comprising:
determining, using statistical models, a statistical relationship that explains the causal correlation, including a confidence factor for the statistical relationship; and
based on the statistical relationship, outputting, at least one second modification in the configuration parameter that is likely to affect the empirical distribution of the first variability benchmark.

14. The method of claim 13, wherein the statistical models include at least one of:
a regressive curve fit; a Bayesian inference; a statistical correlation; and an analysis of variance (ANOVA); and a decision tree statistical model.

15. A computer system for predicting computer performance variability, the computer system including at least one processor configured for:
providing a machine-learning (ML) model that is trained to predict a true distribution of a first variability benchmark of a first application based on learning empirical distributions of telltale indicators and empirical distributions of variability benchmarks associated with executing the first application on a first computer system having a first configuration; and
receiving, from the ML model, output information indicative of the true distribution of the first variability benchmark for the first configuration, including information indicative of a confidence interval of the output information.

16. The computer system of claim 15, further comprising:
receiving, from the ML model, output information indicative of the true distribution of the first variability benchmark for a second configuration different from the first configuration.

17. The computer system of claim 15, further comprising:
receiving, from the ML model, output information indicative of the true distribution of the first variability benchmark associated with executing a second application different from the first application.

18. The computer system of claim 15, wherein the first variability benchmark is selected from at least one of: a run time, a response latency, a response latency probability, a data throughput rate, a makespan, an end timestamp, a start timestamp, or a data throughput capacity.

19. The computer system of claim 15, wherein the first configuration for the first computer system specifies at least one of:
central processing unit (CPU) parameters, including a base clock frequency, a cache memory size, a number of cores, a number of logical processors, peripheral bus clock speed;
graphics processing unit (GPU) parameters, including GPU version, GPU clock speed, GPU cache memory;
memory parameters, including physical memory size, number of memory cards, memory card size, memory interface, nominal memory write speed, nominal memory read speed, nominal memory latency, number of lanes, memory clock speed, memory access control, memory allocation control;
operating system (OS) parameters, including version number, number of updates, update list, registry contents, directory contents, power management mode;
network parameters, including network capacity, number of physical ports, type of physical ports, media type; or
local storage parameters, including number of physical volumes, number of logical volumes, size of volumes, capacity/volume, file system identifier, file system version, storage media type, redundant volumes, file system write speed, file system read speed.

20. The computer system of claim 15, wherein the telltale indicators include at least one of:
central processing unit (CPU) metrics, including CPU % utilization, actual clock frequency, number of processes, number of threads, number of handles, cache events, CPU events, cycle counts, instruction counts, IO events, operating system events, a core identifier;
graphics processing unit (GPU) metrics, including GPU % utilization, GPU memory usage, GPU shared memory;
memory metrics, including memory usage, memory available, memory committed, memory cached, memory paged, memory non-paged;
operating system (OS) metrics, including application runtime duration, code segment runtime duration, virtual memory size, application CPU time duration, application end timestamp, code segment end timestamp;
network metrics, including throughput rate, send data rate, receive data rate, network capacity rate, packet error rate, application network data usage, application network data rate; or
local storage metrics, including response time, average response time, % active time, transfer rate, file system latency, write speed, read speed, access time.
